(19) United States
(12) Patent Application Publication
(10) Pub. No.: US 2026/0302867 A1
(43) Pub. Date: Oct. 1, 2026

(54) ROTATING ELECTRIC MACHINE

(71) Applicant: HONDA MOTOR CO., LTD., Tokyo (JP)

(72) Inventors: Yudai Hirose, Wako-shi (JP); Yuki Abe, Wako-shi (JP); Tatsuya Choji, Wako-shi (JP)

(21) Appl. No.: 19/578,105

(22) Filed: Mar. 25, 2026

(30) Foreign Application Priority Data
Mar. 26, 2025 (JP) 2025-052417

(51) Int. Cl. H02K 3/487; H02K 7/18; H02K 21/16; F02C 6/00

(52) U.S. Cl. CPC H02K 3/487; H02K 7/1823; H02K 21/16; F02C 6/00; F05D 2220/76

(57) ABSTRACT

In a rotating electric machine, each of a plurality of teeth portions constituting a stator core include a flange portion. An inter-flange region is formed between two adjacent flange portions. A stator includes a wedge member. A bulging portion of the wedge member is inserted into a slot, and abuts against an inner circumferential end part of an electromagnetic coil. A fitting convex portion of the wedge member is fitted into the inter-flange region.

### CROSS-REFERENCE TO RELATED APPLICATIONS

This application is based upon and claims the benefit of priority from Japanese Patent Application No. 2025-052417 filed on Mar. 26, 2025, the contents of which are incorporated herein by reference.

### BACKGROUND OF THE INVENTION

### FIELD OF THE INVENTION

The present disclosure relates to a rotating electric machine.

### DESCRIPTION OF THE RELATED ART

A rotating electric machine such as a motor or a generator or the like is equipped with a rotor having permanent magnets and a rotating shaft, and a stator having electromagnetic coils. A stator core that constitutes the stator includes a plurality of teeth portions that extend along a radial direction of the stator core. Slots are formed between each of two adjacent teeth portions from among a plurality of teeth portions. The electromagnetic coils are disposed in slots by winding wires around each of the teeth portions.

JP 2023-163371 A discloses a rotating electric machine in which an insulating spacer is inserted into a slot opening between two adjacent teeth portions. The spacer prevents the potting material in the slot from protruding from the slot opening.

### SUMMARY OF THE INVENTION

The inner circumferential end part of each of the teeth portions and the vicinity thereof receive the magnetic force of the permanent magnets, are regions where the magnetic flux is relatively concentrated. When a part of the electromagnetic coil enters such a magnetic flux concentration region, the leakage of magnetic flux increases. In addition, copper loss in the electromagnetic coil is large.

The present invention has the object of solving the aforementioned problem.

An aspect of the present disclosure is characterized by a rotating electric machine equipped with a rotor including a rotating shaft, and a stator positioned on an outer circumference of the rotor, wherein the stator includes a stator core, an electromagnetic coil provided in a slot of the stator core, and a wedge member made of an electrical insulator and disposed in the slot, the stator core includes a yoke portion having a cylindrical shape, a plurality of teeth portions extending along a radial direction of the yoke portion from an inner circumferential surface of the yoke portion, and a plurality of the slots each formed between two adjacent teeth portions from among the plurality of teeth portions, each of the plurality of teeth portions includes a rod portion and a flange portion that is continuous with an inner circumferential end of the rod portion in the radial direction and has a width along a circumferential direction of the yoke portion larger than a width of the rod portion, and an inter-flange region is formed between the flange portions of the two adjacent teeth portions from among the plurality of teeth portions, the wedge member includes a bulging portion that bulges outwardly in the radial direction and a fitting convex portion that is continuous with the bulging portion and protrudes inwardly in the radial direction, and the fitting convex portion is fitted into the inter-flange region and sandwiched between the flange portions, and the bulging portion is inserted into one of the slots and abuts against an inner circumferential end part of the electromagnetic coil in the radial direction.

In accordance with the present disclosure, a situation is avoided in which the leakage of magnetic flux increases. Further, it is possible to avoid a situation in which the copper loss of the electromagnetic coil becomes large. Accordingly, losses are reduced, and the electrical power generating efficiency is improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic perspective view of a combined motive power system;

FIG. 2 is a schematic cross-sectional side view of the rotating electric machine system as viewed in a direction perpendicular to the axial direction of a rotating shaft;

FIG. 3 is a front cross-sectional view of a principal part of a U-phase electromagnetic coil taken along a radial direction, and further, a stator viewed in the axial direction of a rotating shaft;

FIG. 4 is an enlarged view of a principal part shown in FIG. 3;

FIG. 5 is a schematic perspective view showing a connection pattern between a U-phase coil unit to a W-phase coil unit, and a neutral point bus bar;

FIG. 6 is a schematic perspective view showing a connection pattern between the U-phase coil unit and the neutral point bus bar;

FIG. 7 is a schematic perspective view showing a connection pattern between the V-phase coil unit and the neutral point bus bar;

FIG. 8 is a schematic perspective view showing a connection pattern between the W-phase coil unit and the neutral point bus bar;

FIG. 9 is a front cross-sectional view of a principal part showing a stacked portion that is formed by a different stacking pattern from that shown in FIG. 3;

FIG. 10 is an equivalent circuit formed by the U-phase coil unit, the V-phase coil unit, the W-phase coil unit, and the neutral point bus bar; and

FIG. 11 is a graph showing the loss in the case that the stacking pattern in the stacked portion is changed.

### DETAILED DESCRIPTION OF THE INVENTION

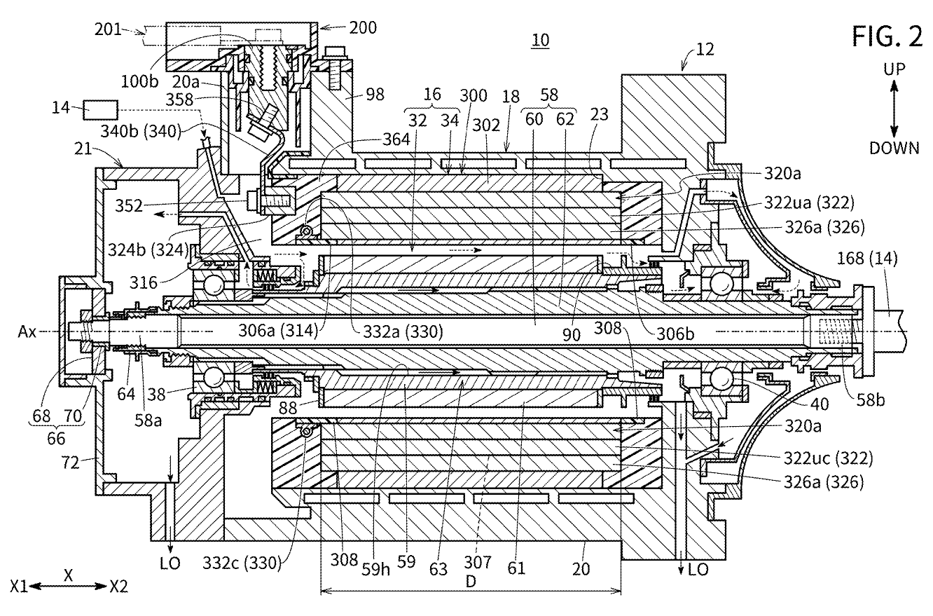

Hereinafter, a description will be given concerning an aspect in which a rotating electric machine 16 as shown in FIG. 2 is a three-phase generator. However, this aspect is simply an example in order to simplify the description and facilitate understanding. The rotating electric machine 16 may be a single-phase or a two-phase generator, or may be a generator having four or more phases. Further, the rotating electric machine 16 may be a motor.

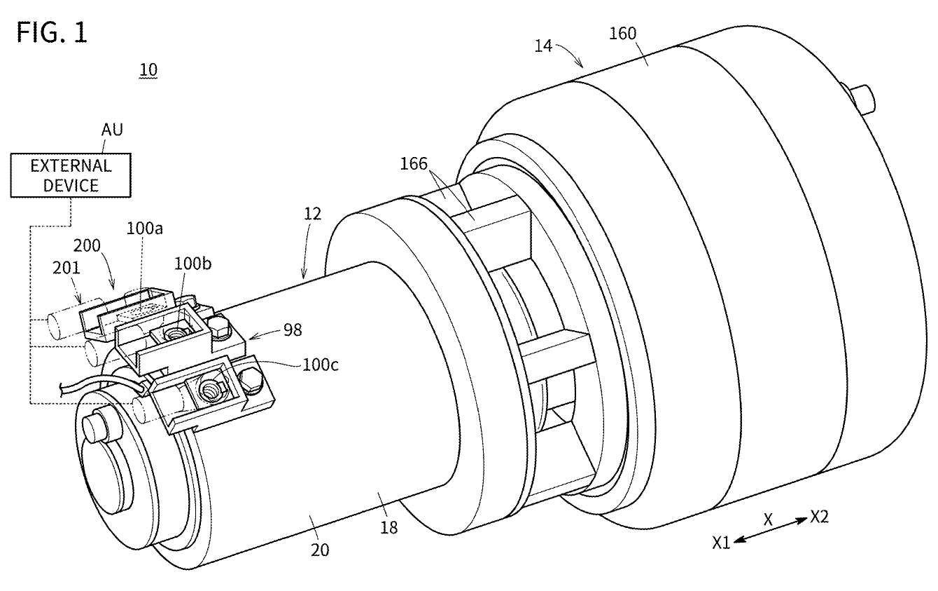

A combined motive power system 10 shown in FIG. 1 is equipped with a rotating electric machine system 12 according to the present embodiment, and a gas turbine engine 14 which is an internal combustion engine. An axial line of the rotating electric machine system 12, and an axial line of the gas turbine engine 14 coincide with each other. Stated otherwise, the rotating electric machine system 12 and the gas turbine engine 14 are arranged in series on the same axial line.

The combined motive power system 10 is used, for example, as a motive power source for providing propulsion in a flying object, a ship, an automobile, or the like. Suitable specific examples of the flying object include drones and multi-copters. The combined motive power system 10, when mounted on a flying object, is used as a power drive source for rotationally driving, for example, a prop, a ducted fan, or the like. The combined motive power system 10, when mounted on a ship, is used as a screw rotational force generating device. The combined motive power system 10, when mounted on an automobile, is used as a power drive source for rotating a motor.

The combined motive power system 10 can also be used as an auxiliary electrical power source in an aircraft, a ship, a building, or the like. Apart therefrom, it is also possible to utilize the combined motive power system 10 as gas turbine power generation equipment.

In the description that follows, unless otherwise specified, the term "axial direction" refers to an axial direction of a rotating shaft 58 shown in FIG. 2. Unless otherwise specified, the terms "circumferential direction" and "radial direction" refer respectively to the axial direction and the radial direction of the rotating shaft 58 shown in FIG. 2.

A resolver rotor 68 is fixed to an X1 side end part of an inner shaft 60. A resolver stator 70 is disposed in a manner so as to surround the resolver rotor 68. The resolver stator 70 is retained by a resolver holder 72 that is attached to a first sub-housing 21. The resolver rotor 68 and the resolver stator 70 constitute a resolver 66.

Hereinafter, the X1 side end part of the rotating shaft 58 will be referred to as a first shaft end 58a, and an X2 side end part of the rotating shaft 58 will be referred to as a second shaft end 58b. The aforementioned fixing structure is disposed on the first shaft end 58a.

As shown in FIG. 2, a sleeve 59 is a hollow cylindrical member having an inner hole 59h. The rotating shaft 58 is inserted into the inner hole 59h of the sleeve 59. A major portion of a rotor internal flow path 63 is formed by the sleeve 59 and the rotating shaft 58. The sleeve 59 surrounds the rotating shaft 58.

The sleeve 59 is fixed, for example, by shrink fitting, to an outer surface of the rotating shaft 58. Permanent magnets 61 are retained in the sleeve 59.The permanent magnets 61 are fixed to an outer circumferential surface of the sleeve 59 by a first magnet stopper 88 and a second magnet stopper 90. In the illustrated example, a rotor 32 is a so-called SPM (surface permanent magnet) type in which the permanent magnets 61 are disposed on the outer circumferential surface of the sleeve 59. Alternatively, the rotor 32 may be a so-called IPM (interior permanent magnet) type in which the permanent magnets 61 are embedded in the sleeve 59.

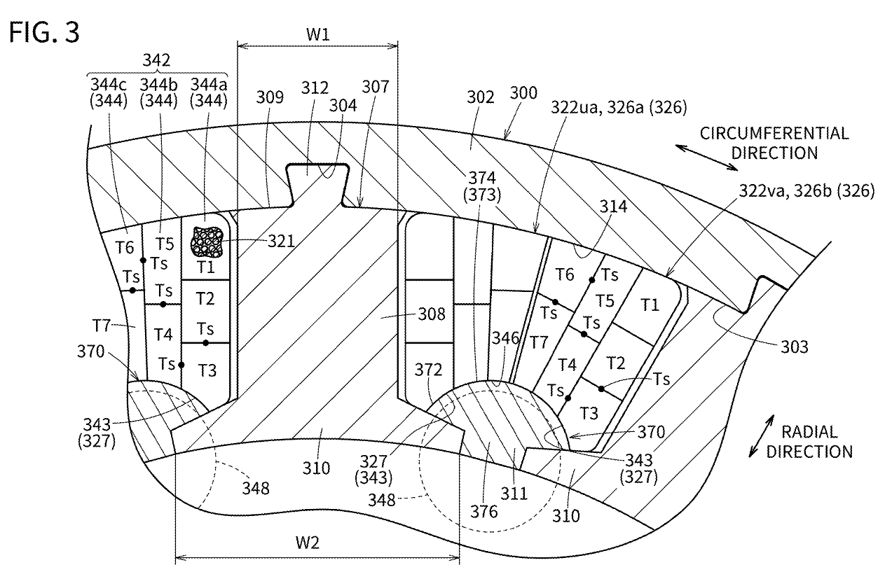

As shown in FIG. 3, a stator 34 includes a stator core 300. The stator core 300 includes a yoke portion 302, and a plurality of teeth portions 307. Slots 314 are formed between each of two adjacent ones from among the plurality of teeth portions 307. Electromagnetic coils 326, which will be described later, are disposed in the slots 314. When the yoke portion 302 is viewed in the axial direction, the yoke portion 302 has a circular ring-like shape. As shown in FIG. 2, the yoke portion 302 extends along the axial direction. Accordingly, the yoke portion 302 has a cylindrical shape.

The plurality of teeth portions 307 project out from an inner circumferential surface 303 of the yoke portion 302, in a manner so as to extend along the radial direction of the yoke portion 302. The protruding direction of each of the teeth portions 307 is a direction toward an inner side in the radial direction of the yoke portion 302. Each of the teeth portions 307 extends along the axial direction in the interior of the yoke portion 302. The axial length of the yoke portion 302 and the axial length of the teeth portions 307 are substantially the same as each other. The number of the teeth portions 307 is twelve. However, the number of the teeth portions 307 is not necessarily limited to being twelve.

As shown in FIG. 3, each of the plurality of teeth portions 307 comprises a rod portion 308 and a flange portion 310. The rod portion 308 is a portion that extends in a linear shape along the radial direction. The flange portion 310 is a portion that is continuous with a radially directed inner circumferential end of the rod portion 308. In the rod portion 308, the length along the circumferential direction is defined as a first width W1. In the flange portion 310, the length along the circumferential direction is defined as a second width W2. The first width W1 is smaller than the second width W2.

As shown in FIG. 2, the length of each of the teeth portions 307 along the axial direction is denoted by D. The length D, for example, is 8 to 10 times that of the first width W1. In this case, the aspect ratio of each of the teeth portions 307 is from 8 to 10. However, the aspect ratio of each of the teeth portions 307 is not necessarily limited to lying within a range of from 8 to 10.

In the illustrated example, the stator core 300 can be separated into the yoke portion 302 and the plurality of teeth portions 307. Hereinafter, this aspect will be specifically described. However, the stator core 300 may be made from a laminate of thin electromagnetic steel sheets in which the yoke portion 302 and the plurality of teeth portions 307 are integrally formed.

As shown in FIG. 3, the yoke portion 302 comprises a first engagement member 304. The first engagement member 304, for example, is a concave engagement member that is recessed toward an outer side in the radial direction from the inner circumferential surface 303 of the yoke portion 302. The first engagement member 304 becomes wider in the circumferential direction as it extends outwardly in the radial direction. More specifically, the first engagement member 304 is of a so-called flared shape.

Each of the plurality of teeth portions 307 comprises a second engagement member 312. The second engagement member 312 engages with the first engagement member 304. In the case that the first engagement member 304 is a concave engagement member, the second engagement member 312 is a convex engagement member. The second engagement member 312 has a shape corresponding to the shape of the first engagement member 304. More specifically, in the second engagement member 312, an end portion thereof facing toward an outer side in the radial direction is wider than an end portion thereof facing toward an inner side in the radial direction. Therefore, the second engagement member 312 that is inserted into the first engagement member 304 is prevented from moving beyond a predetermined distance inwardly in the radial direction. In accordance with this feature, in the radial direction, the second engagement member 312 is prevented from coming off from the first engagement member 304.

Conversely to the foregoing, the first engagement member 304 may be a convex engagement member, and further, the second engagement member 312 may be a concave engagement member. In this case, the concave engagement member that is provided on each of the teeth portions 307 becomes wider in the circumferential direction as it extends inwardly in the radial direction. In the convex engagement member that is provided on the yoke portion 302, the end portion facing inwardly in the radial direction is wider than an end part facing toward an outer side in the radial direction.

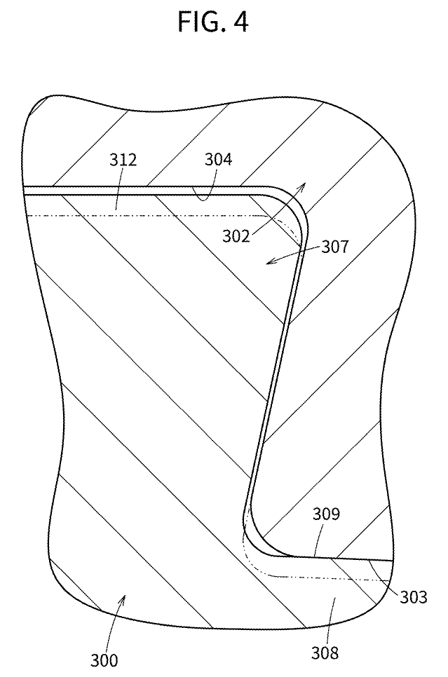

Bulging portions 372 of later-described wedge members 370 are inserted into the slots 314. The electromagnetic coils 326 are pushed outwardly in the radial direction by the bulging portions 372. In accordance with this feature, as shown in FIG. 4, an outer circumferential side end surface 309 of the rod portion 308 of each of the teeth portions 307 abuts in a manner of being in tight contact with the inner circumferential surface 303 of the yoke portion 302. Since the wedge members 370 remain within the slots 314, a state is brought about in which the teeth portions 307 receive, via U-phase coils 326aand V-phase coils 326b, a pressing force of the wedge members 370 that presses the U-phase coils 326a and the V-phase coils 326b outwardly in the radial direction. Moreover, it should be noted that a very small clearance may be formed between the side surface of the second engagement member 312 and the inner surface of the first engagement member 304.

As noted previously, the stator core 300 and the yoke portion 302 extend along the axial direction (refer to FIG. 2). A first insulator 306a and a second insulator 306b are respectively disposed on an X1 side end part and an X2 side end part of the yoke portion 302. Each of the first insulator 306a and the second insulator 306b is substantially U-shaped. The first insulator 306a and the second insulator 306b are respectively positioned more outwardly in the radial direction than the X1 side end part and the X2 side end part of the stator core 300.

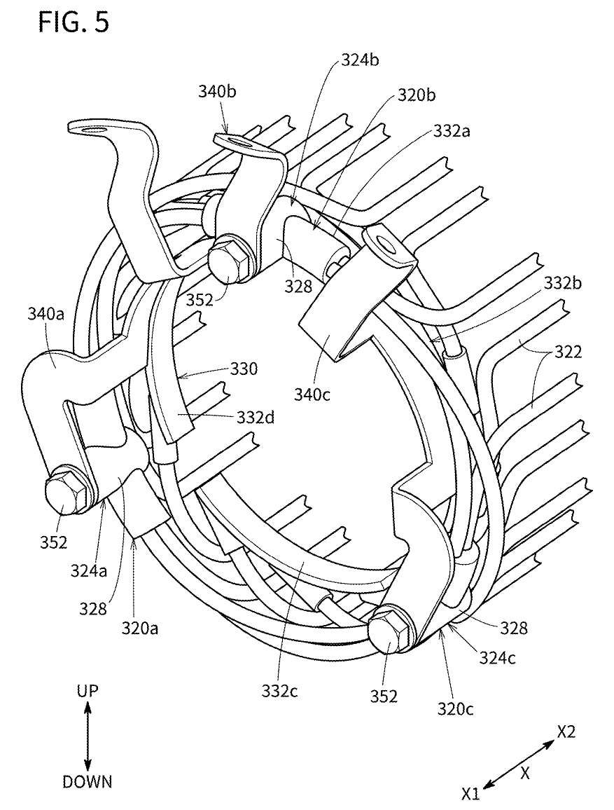

As shown in FIG. 5, the stator 34 includes a U-phase coil unit 320a, a V-phase coil unit 320b, and a W-phase coil unit 320c. When a description is given taking the U-phase coil unit 320a as an example, the U-phase coil unit 320a comprises a plurality of winding bundles 322 (four in the illustrated example). As shown in FIG. 3, each of the winding bundles 322 is a bundle of a plurality of conductive wires 321. One individual winding bundle 322 includes, for example, 40 to 50 conductive wires 321. Moreover, in each of the drawings, one winding bundle 322 is shown as one wire body.

The U-phase coil unit 320a further includes a U-phase bundling portion 324a. The U-phase bundling portion 324a is formed by bundling and connecting together end parts of the plurality of winding bundles 322. The U-phase bundling portion 324a comprises a connection terminal 328. On the other hand, other end parts of the plurality of winding bundles 322 are electrically connected to a neutral point bus bar 330.

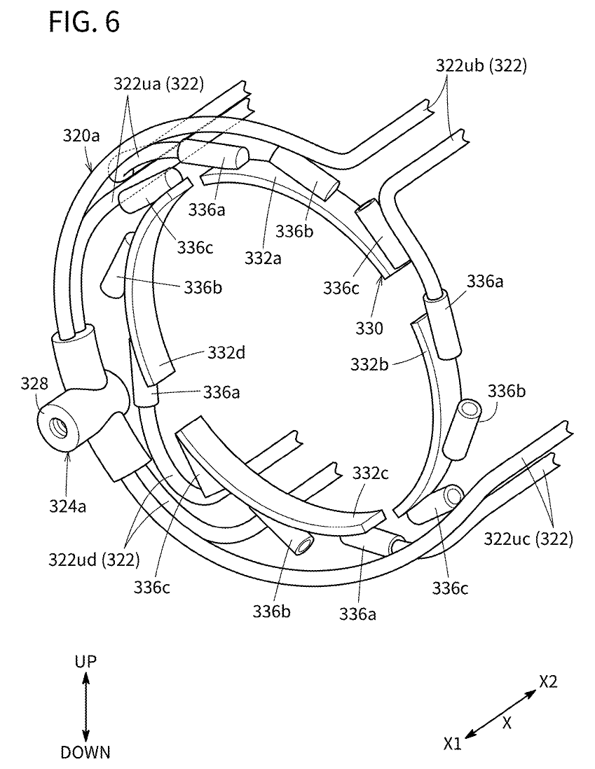

FIG. 6 is a schematic perspective view showing a connection pattern between the U-phase coil unit 320a and the neutral point bus bar 330. Moreover, in FIG. 6, illustration of the V-phase coil unit 320b and the W-phase coil unit 320c is omitted. In the U-phase coil unit 320a, the number of the winding bundles 322 is a number obtained by dividing the number of the teeth portions 307 by the number of the phases. In the aspect shown in FIG. 3, the number of the teeth portions 307 is twelve, and the rotating electric machine 16 is a three-phase generator. Accordingly, the U-phase coil unit 320a includes four individual ones of the winding bundles 322. Hereinafter, in order to distinguish between them, the four individual winding bundles 322 may be referred to respectively as a first U-phase bundle 322ua, a second U-phase bundle 322ub, a third U-phase bundle 322uc, and a fourth U-phase bundle 322ud. Further, in the U-phase bundling portion 324a, respective end parts of the first U-phase bundle 322ua, the second U-phase bundle 322ub, the third U-phase bundle 322uc, and the fourth U-phase bundle 322ud are bundled together.

The four individual U-phase electromagnetic coils 326 are formed respectively by winding the first U-phase bundle 322ua, the second U-phase bundle 322ub, the third U-phase bundle 322uc, and the fourth U-phase bundle 322ud around the four individual teeth portions 307. Hereinafter, the U-phase electromagnetic coils 326 will be referred to as "U-phase coils 326a." In FIG. 3, there is shown the U-phase coil 326a which is formed by means of concentrated winding of the first U-phase bundle 322ua. However, the method of winding may also be distributed winding. Moreover, the winding bundle 322 (the U-phase coil 326a) is also wound around the first insulator 306a and the second insulator 306b.

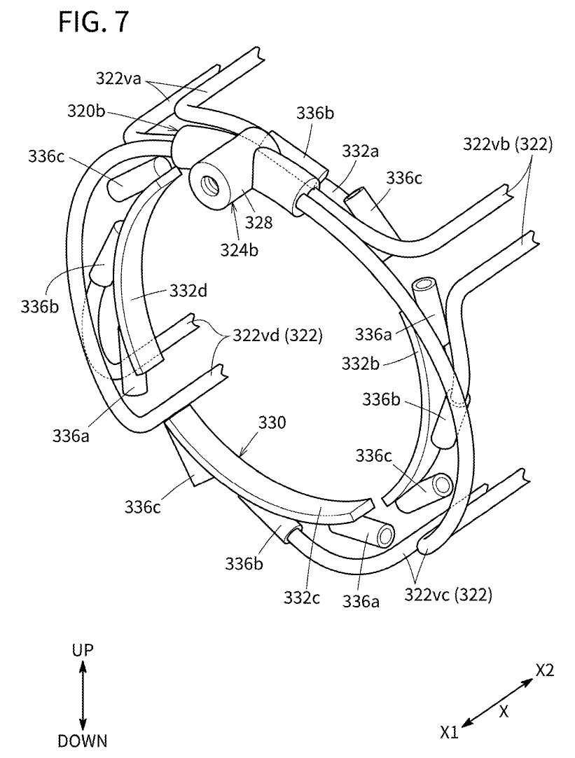

As shown in FIG. 7, the V-phase coil unit 320b includes four individual ones of the winding bundles 322 in a similar manner to the above-mentioned structure. Hereinafter, in order to distinguish between them, the four winding bundles 322 may be referred to respectively as a first V-phase bundle 322va, a second V-phase bundle 322vb, a third V-phase bundle 322vc, and a fourth V-phase bundle 322vd. The four individual V-phase coils 326b (the V-phase electromagnetic coils 326) are formed respectively by winding the first V-phase bundle 322va, the second V-phase bundle 322vb, the third V-phase bundle 322vc, and the fourth V-phase bundle 322vd around the four individual teeth portions 307 that are respectively adjacent to the aforementioned four individual teeth portions 307. In FIG. 3, there is shown the V-phase coil 326b which is formed by means of concentrated winding of the first V-phase bundle 322va. In a V-phase bundling portion 324b of the V-phase coil unit 320b, respective end parts of the first V-phase bundle 322va, the second V-phase bundle 322vb, the third V-phase bundle 322vc, and the fourth V-phase bundle 322vd are bundled together.

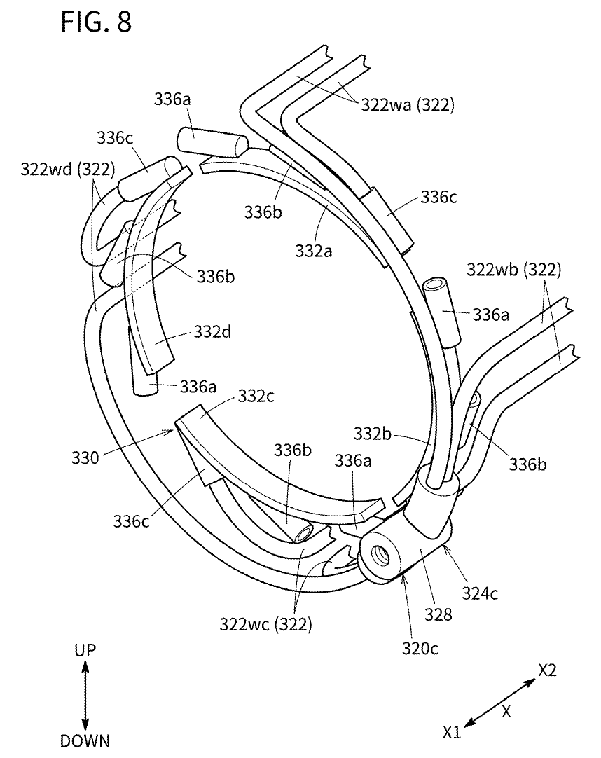

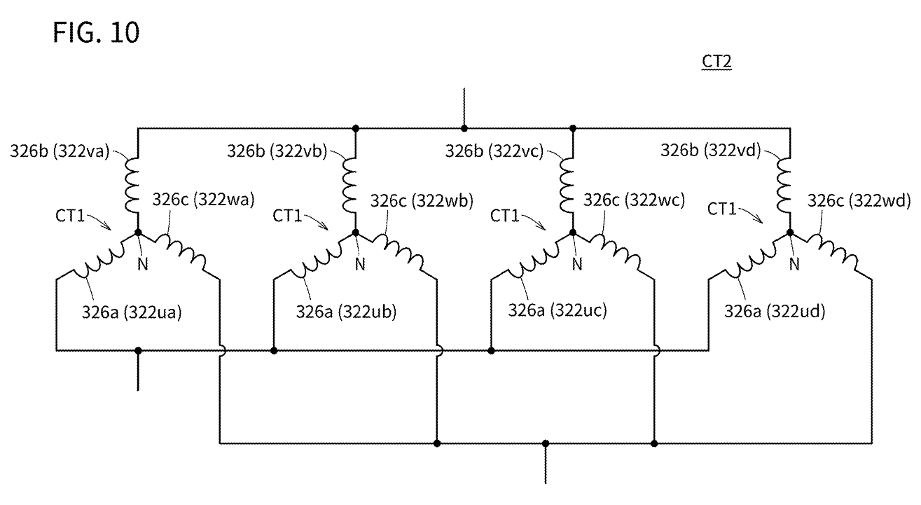

Furthermore, as shown in FIG. 8, the W-phase coil unit 320c includes four individual ones of the winding bundles 322. Hereinafter, in order to distinguish between them, the four winding bundles 322 may be referred to respectively as a first W-phase bundle 322wa, a second W-phase bundle 322wb, a third W-phase bundle 322wc, and a fourth W-phase bundle 322wd. Four individual W-phase coils 326c (the W-phase electromagnetic coils 326), as shown in FIG. 10, are formed by winding the first W-phase bundle 322wa, the second W-phase bundle 322wb, the third W-phase bundle 322wc, and the fourth W-phase bundle 322wd around the four individual teeth portions 307 that are respectively adjacent to the four individual teeth portions 307 on which the four V-phase coils 326b are formed. As shown in FIG. 8, in a W-phase bundling portion 324c of the W-phase coil unit 320c, respective end parts of each of the first W-phase bundle 322wa, the second W-phase bundle 322wb, the third W-phase bundle 322wc, and the fourth W-phase bundle 322wd are bundled together.

As shown in FIG. 5, the rotating electric machine 16 includes the neutral point bus bar 330. The neutral point bus bar 330 comprises a first bus bar segment 332a, a second bus bar segment 332b, a third bus bar segment 332c, and a fourth bus bar segment 332d. As shown in FIG. 6, the first U-phase bundle 322ua is connected to a first connecting portion 336a of the first bus bar segment 332a. As shown in FIGS. 7 and 8, the first V-phase bundle 322va and the first W-phase bundle 322wa are respectively connected to a second connecting portion 336b and a third connecting portion 336c of the first bus bar segment 332a.

The second U-phase bundle 322ub, the second V-phase bundle 322vb, and the second W-phase bundle 322wb are respectively connected to the first connecting portion 336a, the second connecting portion 336b, and the third connecting portion 336c in the second bus bar segment 332b. The third U-phase bundle 322uc, the third V-phase bundle 322vc, and the third W-phase bundle 322wc are respectively connected to the first connecting portion 336a, the second connecting portion 336b, and the third connecting portion 336c in the third bus bar segment 332c. Furthermore, the fourth U-phase bundle 322ud, the fourth V-phase bundle 322vd, and the fourth W-phase bundle 322wd are respectively connected to the first connecting portion 336a, the second connecting portion 336b, and the third connecting portion 336c in the fourth bus bar segment 332d.

A description will be given with reference to FIG. 3 concerning a pattern of winding the electromagnetic coils 326. As noted previously, in FIG. 3, there is shown the U-phase coil 326a which is formed by the first U-phase bundle 322ua.

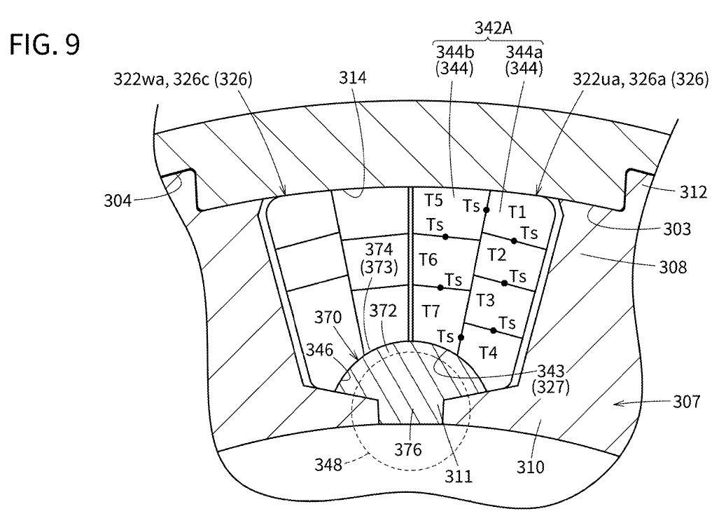

The U-phase coil 326a includes a stacked portion 342 that is formed by winding the first U-phase bundle 322ua around the tooth portion 307. The stacked portion 342 is formed by stacking at least two of winding layers 344 together. In FIG. 3, the number of the individual winding layers 344 is three. Hereinafter, the innermost winding layer 344 that abuts against the tooth portion 307 is referred to as a first winding layer 344a. The winding layer 344 that directly covers the first winding layer 344a is referred to as a second winding layer 344b, and the winding layer 344 that directly covers the second winding layer 344b is referred to as a third winding layer 344c. Moreover, in an aspect in which the number of the winding layers 344 is two (refer to FIG. 9), the stacked portion 342 does not include the third winding layer 344c. Further, in an aspect (not shown) in which the number of the winding layers 344 is four, the stacked portion 342 includes a fourth winding layer.

The first U-phase bundle 322ua is wound around the outer surfaces of the first insulator 306a, the tooth portion 307, and the second insulator 306b, in a manner so as to make round trips multiple times in the axial direction of the tooth portion 307. Due to such round trips, a plurality of the turns are formed. A first turn T1 is formed by a first round trip, and a second turn T2 is formed by a second round trip of the first U-phase bundle 322ua. In FIG. 3, a state is shown in which, by the first U-phase bundle 322ua making seven round trips, the first turn T1 to a seventh turn T7 are formed. However, the number of turns is not necessarily limited to seven.

In the illustrated example, in the first winding layer 344a, the first turn T1, the second turn T2, and the third turn T3 are arranged along the radial direction. Moreover, the first turn T1 is a turn that is formed first in the first winding layer 344a, and the third turn T3 is a turn that is formed last in the first winding layer 344a. As can be understood from this feature, in the case of forming the first winding layer 344a, the first U-phase bundle 322ua, when being wound with respect to the tooth portion 307, moves from an outer side toward an inner side in the radial direction.

In the second winding layer 344b, a fourth turn T4 and a fifth turn T5 are arranged along the radial direction. The fourth turn T4 is a turn that is formed first in the second winding layer 344b, and the fifth turn T5 is a turn that is formed last in the second winding layer 344b. More specifically, when the second winding layer 344b is formed, the first U-phase bundle 322ua moves from an inner side toward an outer side in the radial direction. The second winding layer 344b is formed on an outer circumferential side of the first winding layer 344a, in a manner so that the fourth turn T4 straddles over the third turn T3 and the second turn T2, and further, the fifth turn T5 straddles over the second turn T2 and the first turn T1.

In the third winding layer 344c, a sixth turn T6 and the seventh turn T7 are arranged along the radial direction. The sixth turn T6 is a turn that is formed first in the third winding layer 344c, and the seventh turn T7 is a turn that is formed last in the third winding layer 344c. More specifically, when the third winding layer 344c is formed, the first U-phase bundle 322ua moves from an outer side toward an inner side in the radial direction. In this manner, the direction of movement of the first U-phase bundle 322ua when forming the third winding layer 344c is the same as the direction of movement of the first U-phase bundle 322ua when forming the first winding layer 344a. The third winding layer 344c is formed on an outer circumferential side of the second winding layer 344b, in a manner so that the sixth turn T6 is positioned on an outer circumference of the fifth turn T5, and further, the seventh turn T7 straddles over the fifth turn T5 and the fourth turn T4.

Although not required, a transposition TS may be formed between a leading turn and a trailing turn that is formed immediately thereafter. The transposition TS is a twisted portion indicating that the conductive wires 321 are inverted by 180 degrees. In FIG. 3, for the sake of convenience, the transposition TS is shown between two of the turns. In the illustrated example, a transposition TS is not formed between the first turn T1 and the second turn T2. In contrast to this feature, the transposition TS is formed between the second turn T2 and the third turn T3. Similarly, in the third turn T3 and thereafter, a transposition TS is formed between the leading turn and the trailing turn that is formed immediately thereafter. In this manner, in the illustrated aspect, each of the first winding layer 344a through the third winding layer 344c includes one individual transposition TS therebetween. The stacked portion 342 includes a transposition TS between the first winding layer 344a and the second winding layer 344b (a transposition TS between the third turn T3 and the fourth turn T4), and a transposition TS between the second winding layer 344b and the third winding layer 344c (a transposition TS between the fifth turn T5 and the sixth turn T6). Accordingly, the stacked portion 342 includes a total of five transpositions TS.

However, the above is but one example. For example, a transposition TS may be formed between the first turn T1 and the second turn T2. Further, when forming the second winding layer 344b, the first U-phase bundle 322ua may be moved from an outer side toward an inner side in the radial direction, and thereby the fourth turn T4 straddling over the first turn T1 and the second turn T2, and the fifth turn T5 straddling over the second turn T2 and the third turn T3 may be provided.

Furthermore, as shown in FIG. 9, the number of the winding layers 344 may be two. In a stacked portion 342A shown in FIG. 9, the first winding layer 344a includes the first turn T1 to the fourth turn T4, and further, the second winding layer 344b includes the fifth turn T5 to the seventh turn T7, and furthermore, a transposition TS is formed at each transition from the preceding turn to the succeeding turn.

Although not illustrated, the number of the winding layers 344 may be four. In this case, each of the first winding layer 344a to the third winding layer 344c includes, for example, two turns. The turn that is included in the fourth winding layer is only one turn, namely, the seventh turn T7. The transposition TS is formed, for example, every time that a transition occurs from a leading turn to a trailing turn.

As shown in FIGS. 3 and 9, in the radial direction, an end part on the inner side of the U-phase coil 326a is an inner circumferential end part 327. The inner circumferential end part 327 of the U-phase coil 326a is a layer distal end 343 of the stacked portion 342. In any of the above-described aspects, a length of each of the at least two winding layers 344 along the radial direction is greatest at the innermost first winding layer 344a of the stacked portion 342, and decreases in a stepwise manner or gradually toward the outer circumference (on an outer side in the circumferential direction) of the stacked portion 342. The layer distal end 343 of the stacked portion 342 comes close to an outer side (or toward the yoke portion 302) in the radial direction as it extends toward the outer side in the circumferential direction.

As shown in FIG. 3, the slot 314 in which there is provided the U-phase coil 326a that is formed from the first U-phase bundle 322ua also has provided therein the V-phase coil 326b that is formed from the first V-phase bundle 322va. The first V-phase bundle 322va is wound, using the same winding pattern as the winding pattern of the first U-phase bundle 322ua, around the tooth portion 307 that is adjacent to the tooth portion 307 around which the first U-phase bundle 322ua is wound. The U-phase coils 326a are first electromagnetic coils, and the V-phase coils 326b are second electromagnetic coils.

Within each of the slots 314, the cross section of the stacked portion 342 of the U-phase coil 326a and the cross section of the V-phase coil 326b are substantially axially symmetric. Therefore, within each of the slots 314, a concave portion 346 is formed between the inner circumferential end part 327 of the U-phase coil 326a (the layer distal end 343 of the stacked portion 342), and the inner circumferential end part 327 of the V-phase coil 326b (the layer distal end 343 of the stacked portion 342), which are recessed toward an outer side (or toward the yoke portion 302) in the radial direction as they extend toward the center in the circumferential direction.

As can be understood from FIG. 3, within each of the slots 314, a region in which the magnetic flux mainly concentrates is formed in proximity to the layer distal ends 343 of the two stacked portions 342 (the concave portions 346) and an inter-flange region 311. Hereinafter, this region will be referred to as a "magnetic flux concentration region 348."

In a preferred aspect, the wedge member 370 shown in FIGS. 3 and 9 is inserted into the concave portion 346 and the inter-flange region 311. The wedge member 370 includes the bulging portion 372, and a fitting convex portion 376 that is continuous with the bulging portion 372. The bulging portion 372 is inserted into the concave portion 346, and the fitting convex portion 376 is fitted into the inter-flange region 311. In this state, the bulging portion 372 bulges outwardly in the radial direction. Further, the fitting convex portion 376 protrudes inwardly in the radial direction. More specifically, the wedge member 370 is disposed in the magnetic flux concentration region 348.

The bulging portion 372, for example, has a shape corresponding to the shape of the concave portion 346. Stated otherwise, it is preferable for the bulging portion 372 to have a shape in which the thickness thereof in the radial direction increases toward a central part in the circumferential direction. A distal end surface 373 of the bulging portion 372 abuts against the layer distal end 343 of the two stacked portions 342 within each of the slots 314. For this reason, it is preferable for the distal end surface 373 (the end surface facing outwardly in the radial direction) of the bulging portion 372 to be a curved surface 374. This is because the curved surface 374 abuts evenly against the inner circumferential end part 327 (the layer distal end 343 of the stacked portion 342) of the U-phase coil 326a, which is the first electromagnetic coil, and presses the U-phase coil 326a outwardly in the radial direction, and further, abuts evenly against the inner circumferential end part 327 (the layer distal end 343 of the stacked portion 342) of the V-phase coil 326b, which is the second electromagnetic coil, and presses the V-phase coil 326b outwardly in the radial direction. Furthermore, in the case that the curved surface 374 is provided, the stress that acts from the bulging portion 372 on the U-phase coil 326a or the V-phase coil 326b is comparatively small.

In the case that the distal end surface 373 is the curved surface 374, the shape of the bulging portion 372 when the wedge member 370 is viewed in the axial direction, for example, is a fan-like shape or an arcuate shape. In the case that the bulging portion 372 has such a simple shape, the wedge member 370 can be manufactured comparatively easily.

The force with which the wedge member 370 presses up the U-phase coil 326a and the V-phase coil 326b acts on the teeth portions 307. More specifically, as noted previously, a pressing force acts on the teeth portions 307 to press them outwardly in the radial direction. In accordance with this feature, as shown in FIG. 4, the outer circumferential side end surface 309 of the rod portion 308 of each of the teeth portions 307 is maintained in a state of having abutted against the inner circumferential surface 303 of the yoke portion 302.

The wedge member 370 extend along the axial direction. The length in the axial direction of the wedge member 370 is approximately the same as the length in the axial direction of the stator core 300 and the length in the axial direction of each of the teeth portions 307.

The wedge member 370 which is configured in this manner is made up from an electrical insulator. Accordingly, for example, a situation is avoided in which a short circuit occurs via the wedge member 370 between the U-phase coil 326a and the V-phase coil 326b.

Concerning the foregoing, the same also applies to the other slots 314. Therefore, a description of the other slots 314 will be omitted.

As shown in FIG. 1, a terminal casing 98 that constitutes a connector portion 200 is integrally provided on an upper surface on a side in the X1 direction of a main housing 20. As shown in FIG. 2, the connector portion 200 comprises a U-phase bus rod 100a, a V-phase bus rod 100b, and a W-phase bus rod 100c. Each of the U-phase bus rod 100a, the V-phase bus rod 100b, and the W-phase bus rod 100c is a rod shaped or a columnar shaped conductive body (terminal).

In FIG. 5, a U-phase bus bar 340a, a V-phase bus bar 340b, and a W-phase bus bar 340c are shown. One end of the V-phase bus bar 340b is electrically connected, via a first screw 352, to the connection terminal 328 of the V-phase bundling portion 324b. As shown in FIG. 2, the other end of the V-phase bus bar 340b is electrically connected, via a second screw 358, to the V-phase bus rod 100b. In accordance with this feature, the V-phase bus rod 100b and the V-phase coil unit 320b (refer to FIGS. 5 and 7) are electrically connected via the V-phase bus bar 340b. Similarly, the U-phase bus rod 100a (refer to FIG. 1) and the U-phase coil unit 320a (refer to FIGS. 5 and 6) are electrically connected via the U-phase bus bar 340a (refer to FIG. 5), and further, the W-phase bus rod 100c (refer to FIG. 1) and the W-phase coil unit 320c (refer to FIGS. 5 and 8) are electrically connected via the W-phase bus bar 340c (refer to FIG. 5).

FIG. 10 shows an equivalent circuit formed by the U-phase coil unit 320a, the V-phase coil unit 320b, and the W-phase coil unit 320c. The U-phase coil unit 320a, the V-phase coil unit 320b, and the W-phase coil unit 320c form a so-called four-parallel Y-connection circuit CT2 having four individual single circuits CT1. As noted previously, the neutral point bus bar 330 includes the first bus bar segment 332a to the fourth bus bar segment 332d (refer to FIGS. 5 to 8). Therefore, as shown in FIG. 10, the neutral points N themselves of the respective individual single circuits CT1 are not electrically connected to each other.

As shown in FIG. 2, the rotating electric machine 16 includes an insulating resin filler 364. The resin filler 364 is filled in a space between the outer surfaces of the first insulator 306a and the second insulator 306b, and the inner circumferential surface of a rotating electric machine housing 18. Therefore, the neutral point bus bar 330 is encapsulated in the resin filler 364.

Next, a description will be given concerning the gas turbine engine 14 shown in FIG. 1. Moreover, it should be noted that the configuration of the gas turbine engine 14, for example, is similar to the configuration shown in FIG. 7 of JP 2023-106078 A. Therefore, the description of the gas turbine engine 14 will be kept brief.

The gas turbine engine 14 is equipped with an engine housing 160. The engine housing 160 is connected to the rotating electric machine housing 18. The engine housing 160 includes a plurality of leg members 166. An air intake space is formed between the leg members 166.

As shown in FIG. 2, the gas turbine engine 14 is equipped with an output shaft 168. A non-illustrated compressor wheel and a non-illustrated turbine wheel are mounted radially outward of the output shaft 168. The output shaft 168 is connected to the rotating shaft 58. The compressor wheel and the turbine wheel are capable of rotating integrally together with the rotating shaft 58 and the output shaft 168. A portion of the air that is generated by the rotation of the compressor wheel is extracted, and is supplied to the rotating electric machine housing 18.

The combined motive power system 10 that is constituted as described above operates in the following manner.

As shown in FIG. 1, at first, an external connector 201 is electrically connected to the connector portion 200. The external connector 201 is a connector that is electrically connected to an external device AU. An example of the external device AU is a battery. In this state, the gas turbine engine 14 is started by driving the rotating electric machine 16 that is shown in FIG. 2. When the gas turbine engine 14 starts, the rotor 32 of the rotating electric machine 16 rotates due to the rotational driving force of the output shaft 168 of the gas turbine engine 14. In accordance with this feature, the combined motive power system 10 is placed in operation.

Accompanying the rotor 32 undergoing rotation, an alternating magnetic field is generated between the permanent magnets 61 and the electromagnetic coils 326. As a result, an induced current is induced in the electromagnetic coils 326. More specifically, generation of electricity is carried out in the rotating electric machine 16. In the case that the external device AU is a battery, the battery is charged with the electrical power obtained from the rotating electric machine 16.

As shown in FIGS. 3 and 9, in the case that the number of turns included in the stacked portions 342 and 342A is seven, the winding density within the slots 314 becomes high. Therefore, the amount of winding that contributes to the generation of electrical power is large.

In addition, each of the wedge members 370 is disposed in the magnetic flux concentration region 348 where the magnetic flux tends to be concentrated, and at this position, the wedge members press the U-phase coils 326a and the V-phase coils 326b outwardly in the radial direction. Accordingly, the U-phase coils 326a and the V-phase coils 326b are prevented from losing their shape. Stated otherwise, the winding density is maintained at a high level. In addition, each of the wedge members 370 prevents the layer distal end 343 from moving inwardly in the radial direction. As a result, a situation is avoided in which the layer distal end 343 moves into the magnetic flux concentration region 348. Consequently, a leakage magnetic flux is suppressed.

Furthermore, as shown in FIG. 4, by each of the teeth portions 307 receiving the force from each of the wedge members 370, the outer circumferential side end surface 309 of the rod portion 308 of each of the teeth portions 307 abuts in a manner of being in tight contact with the inner circumferential surface 303 of the yoke portion 302. Therefore, the contact area between the teeth portions 307 and the yoke portion 302 is large. Accordingly, the contact resistance between the teeth portions 307 and the yoke portion 302 is small.

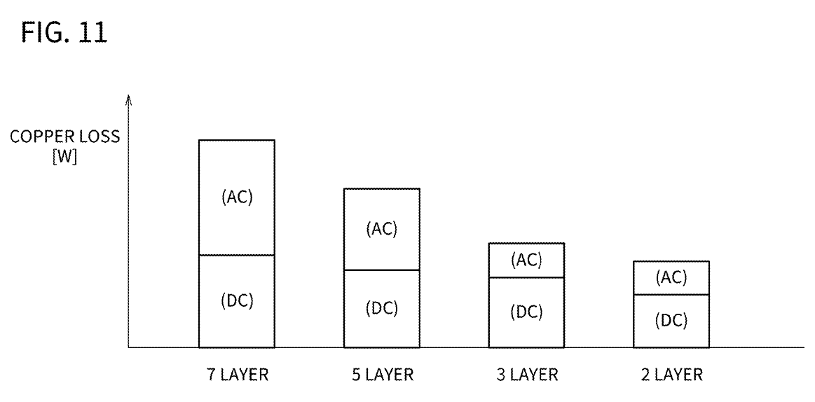

FIG. 11 is a graph showing the loss in the case that the stacking pattern in the stacked portion 342 is changed. The term "7 LAYER" in the graph indicates that the electromagnetic coils 326 have a seven-layer structure, which is obtained by repeating seven times a process of forming one winding layer 344 for each round trip of the winding bundles 322. Accordingly, in this case, each of the seven winding layers 344 is formed with only one turn, and does not include a transposition TS therein. However, a transposition TS is formed between each of the layers and a layer positioned on an outer side in the circumferential direction of that layer.

Further, the term "5 LAYER" indicates that the electromagnetic coils 326 have a five-layer structure in which a first winding layer 344a including a first turn T1, a second turn T2, and a third turn T3 is provided, and thereafter, a second winding layer 344b including only a fourth turn T4, a third winding layer 344c including only a fifth turn T5, a fourth winding layer including only a sixth turn T6, and a fifth winding layer including only a seventh turn T7 are provided. Moreover, the transposition TS is formed every time that a transition occurs from a leading turn to a trailing turn.

Furthermore, the term "3 LAYER" indicates that the electromagnetic coils 326 have a three-layer structure provided by way of the stacking pattern shown in FIG. 3, and the term "2 LAYER" indicates that the electromagnetic coils 326 have a two-layer structure provided by way of the stacking pattern shown in FIG. 9. The term "DC" represents a loss in a direct current, and the term "AC" represents a loss in an alternating current.

Comparing the loss of the "7 LAYER" in FIG. 11 with other losses apart therefrom, it can be understood that by including the plurality of turns in the one winding layer 344, and further, by including at least one transposition TS, the loss in the alternating current is reduced. Moreover, in the case of manufacturing a "3 LAYER" stator 34 (refer to FIG. 3) or a "2 LAYER" stator 34 (refer to FIG. 9), the operation of winding the winding bundles 322 around the teeth portions 307 is comparatively easy. More specifically, the "3 LAYER" stator 34 and the "2 LAYER" stator 34 are capable of suppressing losses in the alternating current, and further, can be easily manufactured.

As noted previously, based on the above-described configuration, losses such as copper loss, iron loss, and the like in the stator 34 become small, and further, the electrical resistance also becomes small. Therefore, the rotating electric machine 16 exhibits superior electrical power generating efficiency. Accordingly, the rotating electric machine 16 is capable of providing a large output.

Further still, as shown in FIGS. 5 to 8, the neutral point bus bar 330 includes the first bus bar segment 332a to the fourth bus bar segment 332d. Therefore, as shown in FIG. 10, the neutral points N of the respective individual single circuits CT1 are not electrically connected to each other. In accordance therewith, even in the case that the control frequency becomes high due to the rotor 32 rotating at a high speed, a situation is avoided in which an eddy current occurs in the neutral point bus bar 330. Accordingly, losses in the rotating electric machine 16 can be reduced.

During operation of the combined motive power system 10, air is supplied from the gas turbine engine 14 into the rotating electric machine housing 18. By means of this air, the rotating electric machine 16 is cooled. Further, the lubricating oil LO is supplied from the oil circulation supply device respectively to a first bearing 38, a second bearing 40, and the rotor internal flow path 63. The lubricating oil LO that is sprayed onto the first bearing 38 and the second bearing 40 lubricates the first bearing 38 and the second bearing 40. The lubricating oil LO flowing through the rotor internal flow path 63 cools the permanent magnets 61. Furthermore, the heat that is generated in the U-phase coils 326a, the V-phase coils 326b, and the W-phase coils 326c is transferred via the resin filler 364 to the rotating electric machine housing 18.

In accordance with the foregoing, a situation is avoided in which the permanent magnets 61 become high in temperature. Therefore, a situation is avoided in which the magnetic force of the permanent magnets 61 decreases.

Furthermore, a part of the air supplied into the rotating electric machine housing 18 is diverted, and serves to cool the U-phase bus rod 100a, the V-phase bus rod 100b, and the W-phase bus rod 100c (refer to FIG. 1). Therefore, the U-phase bus rod 100a, the V-phase bus rod 100b, and the W-phase bus rod 100c are cooled efficiently.

Accordingly, an increase in the electrical resistance of each of the U-phase bus rod 100a, the V-phase bus rod 100b, and the W-phase bus rod 100c is suppressed. Therefore, electrical power of a high output can be obtained from the rotating electric machine 16.

Next, a brief description will be given concerning the work of assembling the rotating electric machine system 12.

In the case of assembling the rotating electric machine system 12, the operator, as shown in FIGS. 6 and 3, winds the first U-phase bundle 322ua to the fourth U-phase bundle 322ud of the U-phase coil unit 320a respectively around the four individual teeth portions 307. In accordance with this feature, four individual U-phase assemblies are obtained. One U-phase assembly includes one of the teeth portions 307, one of the U-phase coils 326a (a winding bundle 322), the first insulator 306a, and the second insulator 306b. Moreover, a non-illustrated winding device is used for the winding and the transposition TS. Further, although this winding method is concentrated winding, distributed winding may also be employed.

In the case that the aspect ratio in the axial direction of each of the teeth portions 307 is 8 to 10, the above-described winding operation with respect to each of the teeth portions 307 is easily performed. Moreover, the winding bundles 322 can be easily transposed in the axial direction. In addition, a loss in shape of the winding bundles 322 due to transpositioning thereof is prevented.

As shown in FIG. 6, the operator, next, in the first U-phase bundle 322ua to the fourth U-phase bundle 322ud, connects the other ends thereof that are not bundled together as the U-phase bundling portion 324a to the respective first connecting portions 336a of the first bus bar segment 332a to the fourth bus bar segment 332d.

The operator, in the same manner as described previously, prepares four individual ones of the V-phase assemblies, and connects the other ends of the first V-phase bundle 322va to the fourth V-phase bundle 322vd to the respective second connecting portions 336b of the first bus bar segment 332a to the fourth bus bar segment 332d (refer to FIG. 7). The operator, furthermore, prepares four individual ones of the W-phase assemblies, and connects the other ends of the first W-phase bundle 322wa to the fourth W-phase bundle 322wd to the respective third connecting portions 336c of the first bus bar segment 332a to the fourth bus bar segment 332d (refer to FIG. 8).

Next, the operator inserts the U-phase assemblies, the V-phase assemblies, and the W-phase assemblies into the stator core 300. In this insertion, the worker inserts the X2 side end part of each of the second engagement members 312 into the X1 side end part of each of the first engagement members 304 of the stator core 300. Thereafter, the stator core 300 is caused to move relatively, in a manner so that the teeth portions 307 move toward the interior of the stator core 300. Moreover, after the U-phase assemblies, the V-phase assemblies, and the W-phase assemblies have been inserted into the stator core 300, the winding bundles 322 may be connected to the first connecting portions 336a to the third connecting portions 336c.

Next, the operator attaches the wedge members 370 (see FIG. 3) to the teeth portions 307. Specifically, at the X2 side end part of the stator core 300, the X1 side end parts of the wedge members 370 are inserted into the concave portions 346 and the inter-flange regions 311, and the wedge members 370 are moved relatively in a manner so that the wedge members 370 advance toward the interior of the stator core 300. In accordance therewith, the bulging portions 372 are inserted into the concave portions 346, and the fitting convex portions 376 are fitted into the inter-flange regions 311.

Next, the operator inserts the stator 34 through an opening in a first housing end 20a of the rotating electric machine housing 18 (refer to FIG. 2). By the stator core 300 abutting against a ring shaped step portion 23 inside the rotating electric machine housing 18, the stator 34 comes to a stop.

Next, the operator inserts the U-phase bus bar 340a, the V-phase bus bar 340b, and the W-phase bus bar 340c (refer to FIG. 5) through openings in the first housing end 20a. Next, using the first screws 352, the operator respectively connects the connection terminals 328 of the U-phase bundling portion 324a, the V-phase bundling portion 324b, and the W-phase bundling portion 324c to the U-phase bus bar 340a, the V-phase bus bar 340b, and the W-phase bus bar 340c. Further, using the second screws 358, the operator respectively connects the U-phase bus bar 340a, the V-phase bus bar 340b, and the W-phase bus bar 340c to the U-phase bus rod 100a, the V-phase bus rod 100b, and the W-phase bus rod 100c. Moreover, it should be noted that at the point in time of carrying out the aforementioned connection work, the rotating shaft 58 has not yet been inserted into the rotating electric machine housing 18.

Next, with respect to the space that is formed between the first insulator 306a and the second insulator 306b, and the inner circumferential surface of the rotating electric machine housing 18, the operator fills the space with the insulating fluid resin from the opening of the first housing end 20a.

As shown in FIG. 2, thereafter, the operator accommodates the rotor 32 and the circumferential members in the hollow interior of the stator 34, and furthermore, closes the opening of the first housing end 20a with the first sub-housing 21. In accordance therewith, the rotating electric machine system 12 is obtained. Thereafter, by the output shaft 168 of the gas turbine engine 14 being coupled to the second shaft end 58b of the rotating shaft 58, the combined motive power system 10 shown in FIG. 1 is obtained.

The present embodiment possesses the following advantageous effects.

As shown in FIG. 3, in the rotating electric machine 16, the electromagnetic coils 326 provided in the slots 314 are constituted by winding the winding bundles 322 in which the plurality of conductive wires 321 are wound, around each of the plurality of teeth portions 307. The electromagnetic coils 326 have the stacked portion 342 that is formed by laminating at least two of the winding layers 344 along the circumferential direction of the yoke portion 302. Each of the at least two winding layers 344 includes a plurality of turns that are aligned along the radial direction, and further, includes at least one transposition TS formed between the plurality of turns. As the layer distal end 343 extends outwardly in the circumferential direction, the layer distal end 343 of the stacked portion 342 is positioned closer to an outer side in the radial direction.

In accordance with this feature, the winding density in the electromagnetic coils 326 is improved. Accordingly, the amount of winding that contributes to the generation of electrical power becomes large. Therefore, while reducing the size and scale of the rotating electric machine 16, it is possible to improve the electrical power generating efficiency. Further, even if the volume of the slots 314 is small, since the winding density can be improved, a large electrical power generating efficiency can be obtained. Furthermore, since the winding density is high, the electromagnetic coils 326 are less likely to lose their shape, and the state in which high electrical power generating efficiency can be obtained is maintained.

The stacked portion 342 includes seven turns. In this case, the electromagnetic coils 326 (the winding bundles 322) can be densely packed into the slots 314. Further, losses due to eddy currents become small.

The stacked portion 342, for example, is formed by stacking the first winding layer 344a to the third winding layer 344c. In one aspect, the first winding layer 344a includes three turns (the first turn T1 to the third turn T3), the second winding layer 344b includes two turns (the fourth turn T4 and the fifth turn T5), and the third winding layer 344c includes two turns (the sixth turn T6 and the seventh turn T7).

In this case, the operation of winding the winding bundles 322 around the respective teeth portions 307 (the operation of providing the electromagnetic coils 326 in the slots 314) is easily performed. Further, since the winding density is high, a loss in shape of the electromagnetic coils 326 is unlikely to occur.

In this case, in the first winding layer 344a, it is preferable for the transposition TS not to be formed between the first turn T1 and the second turn T2, and further, for the transposition TS to be formed between the second turn T2 and the third turn T3. According to this aspect, in comparison with an aspect in which the transposition TS is formed between the first turn T1 and the second turn T2, and further, the transposition TS is formed between the second turn T2 and the third turn T3, losses such as copper loss and the like are reduced.

Furthermore, it is preferable for the transpositions TS to be formed respectively between the third turn T3 and the fourth turn T4 of the second winding layer 344b, between the fourth turn T4 and the fifth turn T5, between the fifth turn T5 and the sixth turn T6 of the third winding layer 344c, and between the sixth turn T6 and the seventh turn T7. In this aspect, losses such as copper loss and the like are further reduced.

It is preferable for the fourth turn T4 to be positioned on an outer side in the circumferential direction of the third turn T3, and further, for the sixth turn T6 to be positioned on an outer side in the circumferential direction of the fifth turn T5. In accordance with this feature, after having completed the winding of the third turn T3, the winding of the fourth turn T4 can be started without causing the winding device to be moved. The same also applies concerning the fifth turn T5 and the sixth turn T6.

In another aspect that differs from that described above, the stacked portion 342 is formed by stacking the first winding layer 344a and the second winding layer 344b. In this case, the first winding layer 344a may include four turns (the first turn T1 to the fourth turn T4), and the second winding layer 344b may include three turns (the fifth turn T5 to the seventh turn T7). The transpositions TS are formed in all of the turns between a leading turn that is wound in advance, and a trailing turn that is wound following the leading turn.

In accordance with this aspect, losses due to eddy currents in the electromagnetic coils 326 become further smaller.

The aspect ratio of the teeth portions 307 is preferably from 8 to 10. In this case, it is easy to form the stacked portion 342 that includes seven turns. Furthermore, the winding bundles 322 can be easily transposed in the axial direction. In addition, a loss in shape of the winding bundles 322 due to transpositioning thereof is prevented.

The stator 34 includes the wedge members 370 that are inserted into the slots 314 between two adjacent ones of the teeth portions from among the plurality of teeth portions 307, and the inner circumferential end parts 327 in the radial direction of the electromagnetic coils 326. Each of the wedge members 370 includes the bulging portion 372 and the fitting convex portion 376. The fitting convex portion 376 is fitted into the inter-flange region 311, and is sandwiched between the flange portions 310 of the teeth portions 307. Each of the bulging portions 372 is inserted into the slot 314, and abuts against the inner circumferential end part 327 of the electromagnetic coil 326.

In accordance with such a configuration, since the winding density of the electromagnetic coils 326 is improved, the amount of winding that contributes to the generation of electrical power can be increased. Accordingly, the electrical power generating efficiency can be improved. Further, since the wedge members 370 press up the electromagnetic coils 326 outwardly in the radial direction, it is unlikely for the electromagnetic coils 326 to lose their shape. Therefore, a situation is avoided in which the inner circumferential end parts 327 of the electromagnetic coils 326 move into the magnetic flux concentration region 348. In accordance with this feature, a situation is avoided in which the leakage magnetic flux becomes large. Further, an increase in copper loss of the electromagnetic coils 326 is also avoided. Accordingly, the electrical power generating efficiency is improved. In addition, the state in which the electrical power generating efficiency is improved continues.

Each of the bulging portions 372 has a shape in which the thickness thereof in the radial direction increases toward a central part in the circumferential direction. Therefore, for example, even in the case that the inner circumferential end part 327 of each of the electromagnetic coils 326 (the layer distal end 343 of the stacked portion 342) includes the concave portion 346, the bulging portion 372 is capable of abutting against the inner circumferential end part 327 of the electromagnetic coil 326.

According to one aspect, in each of the bulging portions 372, the surface (the distal end surface 373) thereof that abuts against the inner circumferential end part 327 of the electromagnetic coil 326 is the curved surface 374. In this case, the shape of the bulging portion 372 when the wedge member 370 is viewed in the axial direction, for example, is a fan-like shape or an arcuate shape.

In the same slot 314, there are positioned the first electromagnetic coil that is wound around one from among the two mutually adjacent ones of the teeth portions 307, and the second electromagnetic coil that is wound around the other from among the two adjacent ones of the teeth portions 307. In FIG. 3, a state is shown in which the U-phase coil 326a (the first electromagnetic coil) and the V-phase coil 326b (the second electromagnetic coil) are positioned in the same slot 314.

Accordingly, it is preferable for the bulging portion 372 of the wedge member 370 to be disposed in the concave portion 346 that is formed by the inner circumferential end part 327 of the first electromagnetic coil, and by the inner circumferential end part 327 of the second electromagnetic coil, and to abut against both of the inner circumferential end part 327 of the first electromagnetic coil and the inner circumferential end part 327 of the second electromagnetic coil.

In accordance with this feature, both of the two electromagnetic coils 326 (the first electromagnetic coil and the second electromagnetic coil) that are positioned in one of the slots 314 can be positioned and fixed by one of the wedge members 370.

The stator core 300 can be separated into the yoke portion 302 and the plurality of teeth portions 307. In this aspect, the yoke portion 302 includes the first engagement members 304, and the plurality of teeth portions 307 respectively includes the second engagement members 312. The stator core 300 is formed by the second engagement members 312 engaging with the first engagement members 304.

In this case, prior to assembling each of the teeth portions 307 on the yoke portion 302, the winding bundles 322 can be respectively wound around the teeth portions 307 and thereby the electromagnetic coils 326 can be provided. Therefore, the electromagnetic coils 326 can be easily provided on the teeth portions 307, respectively.

After the respective teeth portions 307 have been assembled onto the yoke portion 302, the respective teeth portions 307 receive, via the electromagnetic coils 326, the pressing force of the wedge members 370 that presses the electromagnetic coils 326 outwardly in the radial direction. Therefore, since the teeth portions 307 are pressed against the yoke portion 302 and are positioned thereby, the teeth portions 307 are unlikely to separate away from the yoke portion 302. Accordingly, a member (such as a holder or the like) that covers the outer circumferential surface of the stator 34 is not required between the rotating electric machine housing 18 and the stator core 300. Therefore, the size and weight of the rotating electric machine 16 can be reduced. Furthermore, the iron loss of the stator core 300 becomes smaller.

The wedge members 370 extend, along the axial direction, from one end to the other end in the axial direction of the stator core 300. Therefore, over the entire length of the electromagnetic coils 326, the electromagnetic coils 326 can be prevented from losing their shape.

In relation to the above-described embodiment, the following supplementary notes are further disclosed.

### Supplementary Note 1

The rotating electric machine (16) according to the present disclosure includes the rotor (32) including the rotating shaft (58), and the stator (34) positioned on the outer circumference of the rotor, wherein the stator includes the stator core (300), the electromagnetic coil (326) provided in the slot (314) of the stator core, and the wedge member (370) made of the electrical insulator and disposed in the slot, the stator core includes the yoke portion (302) having a cylindrical shape, the plurality of teeth portions (307) extending along the radial direction of the yoke portion from the inner circumferential surface (303) of the yoke portion, and the plurality of the slots each formed between two adjacent teeth portions from among the plurality of teeth portions, each of the plurality of teeth portions includes the rod portion (308) and the flange portion (310) that is continuous with the inner circumferential end of the rod portion in the radial direction and has the width along the circumferential direction of the yoke portion larger than the width of the rod portion, and the inter-flange region (311) is formed between the flange portions of the two adjacent teeth portions from among the plurality of teeth portions, the wedge member includes the bulging portion (372) that bulges outwardly in the radial direction and the fitting convex portion (376) that is continuous with the bulging portion and protrudes inwardly in the radial direction, and the fitting convex portion is fitted into the inter-flange region and sandwiched between the flange portions, and the bulging portion is inserted into one of the slots and abuts against the inner circumferential end part (327) of the electromagnetic coil in the radial direction.

Therefore, the wedge member, a situation is avoided in which the inner circumferential end part of the electromagnetic coil moves into the magnetic flux concentration region. In accordance with this feature, a situation is avoided in which the leakage magnetic flux becomes large. Further, an increase in copper loss of the electromagnetic coil is also avoided. Accordingly, losses in the rotating electric machine are reduced, and the electrical power generating efficiency is improved.

### Supplementary Note 2

In the rotating electric machine according to Supplementary Note 1, the bulging portion may have the shape in which the thickness in the radial direction increases toward the central part in the circumferential direction.

Therefore, for example, even in the case that the inner circumferential end part of the electromagnetic coil includes the concave portion, the bulging portion is capable of abutting against the inner circumferential end part of the electromagnetic coil.

### Supplementary Note 3

In the rotating electric machine according to Supplementary Note 2, the surface (373) of the bulging portion that abuts against the inner circumferential end part of the electromagnetic coil may be the curved surface (374).

In this case, the curved surface is brought into contact with the inner circumferential end part of the electromagnetic coil evenly. In addition, a large stress is prevented from acting on the electromagnetic coil from the curved surface.

### Supplementary Note 4

In the rotating electric machine according to Supplementary Note 3, the bulging portion may have the fan shape or the arch shape when the wedge member is viewed the an axial direction of the rotating shaft.

### Supplementary Note 5

In the rotating electric machine according to any one of Supplementary Notes 1 to 4, in one of the slots, the inner circumferential end part of the first electromagnetic coil (326a) and the inner circumferential end part of the second electromagnetic coil (326b) may form the concave portion (346) having the shape recessed outwardly in the radial direction, the first electromagnetic coil being the electromagnetic coil wound around one of the two adjacent teeth portions, and the second electromagnetic coil being the electromagnetic coil wound around the other of the two adjacent teeth portions, and the bulging portion may be disposed in the concave portion and abut against both the inner circumferential end part of the first electromagnetic coil and the inner circumferential end part of the second electromagnetic coil.

In accordance with such a configuration, both of the two electromagnetic coils (the first electromagnetic coil and the second electromagnetic coil) that are positioned in one of the slots can be positioned and fixed by a single wedge member.

### Supplementary Note 6

In the rotating electric machine according to any one of Supplementary Notes 1 to 5, the stator core may be configured to be separated into the yoke portion and the plurality of teeth portions, and the yoke portion may include the first engagement member (304), each of the plurality of teeth portions may include the second engagement member (312) configured to be engaged with the first engagement member, and the stator core may be formed by engaging the second engagement member with the first engagement member.

In this case, prior to assembling the teeth portions on the yoke portion, the electromagnetic coil can be provided on the teeth portions. Therefore, the winding operation is easy.

### Supplementary Note 7

In the rotating electric machine according to Supplementary Note 6, each of the plurality of teeth portions may be in the state of receiving, via the electromagnetic coil, the force of the wedge member pressing the electromagnetic coil outwardly in the radial direction.

In this case, a loss in shape of the electromagnetic coil is even unlikely to occur.

### Supplementary Note 8

In the rotating electric machine according to any one of Supplementary Notes 1 to 7, the wedge member may extend along the axial direction of the rotating shaft from one end to the other end of the stator core in the axial direction.

In accordance with such a configuration, over the entire length of the electromagnetic coil, the electromagnetic coil can be prevented from losing their shape.

### Supplementary Note 9

In the rotating electric machine according to any one of Supplementary Notes 1 to 8, the electromagnetic coil may be formed by using concentrated winding of the winding around each of the teeth portions.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of the operations and the order of the processes are illustrated as examples, and the present invention is not necessarily limited to these features. The same also applies to cases in which numerical values or mathematical expressions are used in the description of the aforementioned embodiments.

1. A rotating electric machine comprising a rotor including a rotating shaft, and a stator positioned on an outer circumference of the rotor,
wherein the stator comprises a stator core, an electromagnetic coil provided in a slot of the stator core, and a wedge member made of an electrical insulator and disposed in the slot,
the stator core comprises a yoke portion having a cylindrical shape, a plurality of teeth portions extending along a radial direction of the yoke portion from an inner circumferential surface of the yoke portion, and a plurality of the slots each formed between two adjacent teeth portions from among the plurality of teeth portions,
each of the plurality of teeth portions includes a rod portion and a flange portion that is continuous with an inner circumferential end of the rod portion in the radial direction and has a width along a circumferential direction of the yoke portion larger than a width of the rod portion, and an inter-flange region is formed between the flange portions of the two adjacent teeth portions from among the plurality of teeth portions,
the wedge member includes a bulging portion that bulges outwardly in the radial direction and a fitting convex portion that is continuous with the bulging portion and protrudes inwardly in the radial direction, and
the fitting convex portion is fitted into the inter-flange region and sandwiched between the flange portions, and the bulging portion is inserted into one of the slots and abuts against an inner circumferential end part of the electromagnetic coil in the radial direction.

2. The rotating electric machine according to claim 1, wherein the bulging portion has a shape in which a thickness in the radial direction increases toward a central part in the circumferential direction.

3. The rotating electric machine according to claim 2, wherein a surface of the bulging portion that abuts against the inner circumferential end part of the electromagnetic coil is a curved surface.

4. The rotating electric machine according to claim 3, wherein the bulging portion has a fan shape or an arch shape when the wedge member is viewed in an axial direction of the rotating shaft.

5. The rotating electric machine according to claim 1, wherein, in one of the slots, the inner circumferential end part of a first electromagnetic coil and the inner circumferential end part of a second electromagnetic coil form a concave portion having a shape recessed outwardly in the radial direction, the first electromagnetic coil being the electromagnetic coil wound around one of the two adjacent teeth portions, the second electromagnetic coil being the electromagnetic coil wound around another of the two adjacent teeth portions, and
the bulging portion is disposed in the concave portion and abuts against both the inner circumferential end part of the first electromagnetic coil and the inner circumferential end part of the second electromagnetic coil.

6. The rotating electric machine according to claim 1, wherein the stator core is configured to be separated into the yoke portion and the plurality of teeth portions, and
the yoke portion includes a first engagement member, each of the plurality of teeth portions includes a second engagement member configured to be engaged with the first engagement member, and the stator core is formed by engaging the second engagement member with the first engagement member.

7. The rotating electric machine according to claim 6, wherein each of the plurality of teeth portions is in a state of receiving, via the electromagnetic coil, a force of the wedge member pressing the electromagnetic coil outwardly in the radial direction.

8. The rotating electric machine according to claim 1, wherein the wedge member extends along an axial direction of the rotating shaft from one end to another end of the stator core in the axial direction.

9. The rotating electric machine according to claim 1, wherein the electromagnetic coil is formed by using concentrated winding of a winding around each of the teeth portions.
